(19) United States
(12) Patent Application Publication
(10) Pub. No.: US 2005/0154896 A1
(43) Pub. Date: Jul. 14, 2005

(54) Data communication security arrangement and method

(76) Inventors: Mathias Widman, Alingsas (SE); Hans Svensson, Alingsas (SE); Christer Johansson, Alingasa (SE)

Correspondence Address: Steven S. Payne;Suite 1005, 1101 17th Street, N.W., Washington, DC, 20036, US

(21) Appl. No.: 10/953,501

(22) Filed: Sep. 30, 2004

Related U.S. Application Data
(63) Continuation of application No. PCT/SE04/01367, filed on Sep. 22, 2004.
(60) Provisional application No. 60/504,946, filed on Sep. 23, 2003.

(30) Foreign Application Priority Data
Sep. 22, 2003 (SE) 0302524-4

(51) Int. Cl. H04K 1/00

(52) U.S. Cl. 713/182

(57) ABSTRACT

A novel and efficient encryption and decryption method and arrangement is presented for synchronization of a communication session for encrypted transmission or authentication between at least two communicating units, a first unit and a second unit communicating via a communication channel. Each unit comprises a session counter (X, Y). The method comprises a handshake procedure whereby the synchronization of session counters is obtained by successively communicated signatures between said communicating units.

### THE FIELD OF THE INVENTION

The invention relates to synchronization and authentication procedures within data communication in general.

### THE BACKGROUND OF THE INVENTION

Normally, it is difficult to achieve secure encrypted transmission via insecure communication channels, such as public telephone lines, data networks, in radio-transmission operations, and so on. Conventional encrypting algorithms require that keys in the form of private or public keys be transmitted between the units. Such a key transmission does, however, cause practical problems. The keys may be transmitted on separate secure channels, but this solution is inconvenient, expensive and time-consuming. Alternatively, the keys may be transmitted via the insecure channel on which the encrypted message is then to be transmitted. However, this procedure involves a security risk. Also when encrypting systems having so called open keys are used, such as the RSA system, the transmission of the key means that larger and more complex keys and encrypting algorithms are required in order to ensure that the encrypted transmission is sufficiently secure, which naturally involves increased inconvenience and costs.

Similar problems are encountered in order to provide secure verification of units, so called authentication, via insecure communication channels. Such authentication is based on transmission between the units of data that are based on a unique key. For example, the key may be used to encrypt a check sum based on a transmitted or received message. Also in this case one is confronted with the same problems as those found In other encrypted transmission in the case of transmission of keys between the units.

Synchronous Key Generator (SKG) is a method to generate identically, e.g. 160-bit keys synchronously in physically separated locations without sending any information about the key. In this way, a high level of security is reached when it comes to authentication of communicating parties or exchanging classified information by encryption. The technique is suitable for so called “closed environments” with well-defined communicating parties. Such environments are for example a company and its field staff, bank and its customer, VPN's etc.

The international patent application No. WO 01/74007 (incorporated inhere through reference) discloses a method and system for encrypted transmission or authentication between at least two units via an insecure communication channel. The method comprises the steps of: in an initiation procedure, obtaining a common original value to be used in the respective units; synchronising a counting value in each unit; generating a key on the basis of the original value and the counting value in each unit, independently of other units; and using the thus generated keys in a subsequent encrypted transmission or authentication operation.

The SKG can be implemented as software or hardware or a combination of the two. SKG can use 160 bits symmetric keys. There is no need for a third trusted verifying part for the communication setup. SKG can be implemented as software in various forms of hardware devices or as software only solution. Hardware implementation provides the highest level of security. Because of the nature of software and its “hackability”, a software only solution is not recommended at the client node position. Server software though, is protected in other ways and could be regarded as a safe environment.

SKG has low bandwidth demands and high security and is suitable for hand held wireless equipment (e.g. PDA) and cell phones as well as traditional computer related equipments. Other related areas with great potential are telematic, automotive and radio communication (Bluetooth), WLAN (Wireless Local Area Network).

WO 03/026198 relates to a sequence of transmissions encrypted as a set of sub-sequences, each sub-sequence having a different session key. The transmitting device determines when each new session key will take effect, and transmits this scheduled new-key-start-time to the receiving device. In a preferred embodiment, the transmitting device also transmits a prepare-new-key command to the receiving device, to provide a sufficient lead-time for the receiving device to calculate the new session key. Each new key is created using a hash function of a counter index and a set of keys that are determined during an initial key exchange session between the transmitting device and the receiving device. The counter index is incremented at each scheduled new-key-start-time, producing the new session key.

In U.S. Pat. No. 6,377,692, two keys, which are updated in the same updating cycle at different times, are prepared as signature keys (main key and auxiliary key) for electronic signature, and the updating cycle of each key is divided into, for example, three periods. The first and last periods after the updating are used for the auxiliary key while the intermediate period is used for the main key, and an electronic signature is carried out with the main key. The electronic signature is confirmed with either of two confirmation keys, which are updated synchronously with updating the two keys used as the signature keys. This eliminates the need of stopping issuance of the electronic signature or limiting a service offer upon updating the signature keys.

According to U.S. 20020110245, the security key synchronization is maintained between nodes in an optical communications system utilizing out-of-band signalling to indicate that a new key is being used to encrypt subsequent information blocks at the transmitting point and that the new key should be used to decrypt subsequent information blocks at the receiving point. A switch-to-new-key code can be selected from a group of unused codes in an eight bit to ten bit encoding scheme. The switch-to-new-key code can replace an idle code that is used to create sufficient spacing between information blocks. Receipt of the switch-to-new-key code indicates that the new key Is being used to encrypt subsequent information blocks at the transmitting point and triggers a switch to the new key for decrypting subsequent information blocks at the receiving point.

U.S. Patent Publication No. 20030003896, discloses embodiments including a method for synchronizing a cryptosystem. In one embodiment, the method uses existing control data that is transmitted as part of a connection establishment process in a wireless communication system. In one embodiment, messages that are normally sent between a base station and a remote unit during the setup of both originating and terminating calls are parsed to detect a particular control message that indicates the start of telephony data transmission. Detection of this message indicates a point at which encryption/decryption can begin, and is used to synchronize the cryptosystem. Synchronizing a cryptosystem involves generating an RC4 state space in a keyed-autokey (“KEK”) encryption system. In one embodiment, Lower Medium Access Channel (“LMAC”) messages are used according to a wireless communication protocol. This is convenient because the LMAC messages are passed through the same Associated Control Channel (“ACC”) processing that encrypts and decrypts the telephony data.

According to WO 02/47319, a communication system includes at one end of a communications channel, a first cipher generator for generating a succession of ciphers, the generator including a first random number generator for generating a sequence of random numbers, each cipher of the succession of ciphers being based on a respective successive portion of the sequence of random numbers, and a symmetric encryptor for encrypting successive amounts of information for transmission to the other end of the channel, each amount of information being encrypted using a respective one of the succession of ciphers. At the other end of the channel, the system includes a second cipher generator for generating in synchronism with the first cipher generator the same succession of ciphers as the first cipher generator, the second cipher generator including a second random number generator for generating the same sequence of random numbers as the first random number generator, and a symmetric decryptor for decrypting the encrypted successive amounts of information received from the one end of the channel, each amount of information being decrypted using the same respective one of the succession of ciphers as was used to encrypt it by the encryptor at the one end of the channel.

All aforementioned documents disclose a variety of methods for communicating secure data relating to the technical field of the invention. They show state-of-the art examples of, e.g. the use of hash algorithms, synchronous key generators, signature approaches, symmetric keys and synchronization in general. However, no prior art document fully matches all the features of the present invention.

### SHORT DESCRIPTION OF THE INVENTION

The intention of the present Invention is to present an efficient method whereby synchronization and authentication Is performed substantially simultaneously. Further aims are secure communication without need of sending information about the actual key used.

Thus, it is an object of the invention to provide a synchronization method, which guarantees totally synchronized nodes and at the same time performs an authentication.

System SKG is ideal for maintaining a high security level of authentication and encryption for “closed environment” systems like B2B, VPN, Telematic, Internet tunnelling etc. Its small size and low bandwidth requirements makes it ideal for PDA:s, Telecom, WAP, RadioCom (Bluetooth) units, WLAN and so on. That it is very suitable for these kind of applications doesn't make it limited to such, but can of course even be used in a wider perspective of applications like in traditional internet security usage.

For these reasons, a method is provided for synchronization of a communication session for encrypted transmission or authentication between at least two communicating units, a first unit and a second unit each unit comprising a session counter, via a communication channel. The method comprises a handshake procedure whereby the synchronization of session counters is obtained by successively communicated signatures between the communicating units.

Most preferably, the keys are generated identically and synchronously in physically separated locations without providing Information about a key, thus online or offline synchronizations are allowed. Initially, each unit is initiated with a common “seed”, a key for the synchronization. The common key is only used in an initial step and can be replaced at any time, e.g. if destroyed.

The method comprises further steps of: a. first unit initializing the communication by sending a data set comprising the first Unit's identity, a current session counter and a first signature to the second unit, b. receiving by the second unit the data, c. verifying the signature to perform the synchronization, d. the second unit fetches the first signature and sends its identity, a second session counter and the first signature, e. verifying by the first unit the first signature from the second unit, f. performing a synchronization by the first unit, g. obtaining a new key for encryption by the first unit, if both units are synchronised, h. generating a new signature by the first unit and providing it to the second unit, i. verifying by the second unit the second signature, and g. generating a new key by the second unit upon positive verification of the second signature.

Preferably, the first unit (A) encrypts data and transmits data after step h. and the second unit (B) decrypts data received from the first unit (A) after step j.

Preferably but not exclusively, the signatures are generated as a HASH value of any size. The signatures are generated using one or several of algorithms SHA-1, SHA-256 MD5 etc. A key is never reused by agreeing over which unit, has the key with a highest index and using this key as a base for calculating a next session key.

The invention also relates to a communication network comprising at least two communicating units, communicating via a communication channel, each unit comprising means for synchronization of a communication session for encrypted transmission or authentication between the at least two communicating units, a first unit and a second unit. Each unit comprises means for a handshake procedure where a signature and synchronization procedure takes place by successively communicated signatures between the communicating units.

The means may comprise a non-manipulative area, an application code memory, a processing unit and a memory for session key storage. The means consists of a smartcard, software application, an USB-Dongle, Bluetooth unit, RF unit, WLAN or a biometric unit. Most preferably, the software application comprises an encrypted data set containing a key engine and register.

Moreover, the means is arranged to handle more than one key generator, each such a generator acting as a separate communication channel.

The invention also relates to a synchronous key generator (SKG) management arrangement, which can be used as a common access point to several synchronous key generator engines Installed in a system for synchronization of a communication session for encrypted transmission or authentication between at least two communicating units, a first unit and a second unit, each unit comprising a session counter, the arrangement comprising at least one communication interface with a certain type of SKG unit. Each unit comprises means to initiate a handshake procedure whereby the synchronization of session counters is obtained by successively communicated signatures between the communicating units.

Preferably, an application uses the arrangement by loading a device driver. The manager arrangement manages a number of modules, which represent different types of units. Each SKG unit may include a key generator. Preferably, a unit is one of a smartcard, an USB-dongle, a file on disk or a database table or other memory-based devices.

Preferably, a unit comprises different interfaces: an access Interface (710), including functions for formatting, logging in/out, locking the unit, an SKG interface (720) contains functions that handle the key generators such as allocating, initializing, generating and synchronizing, a registry Interface (730) implementing a registry used for applications to securely store and retrieve configuration and other types of persistent data in the SKG unit, and a crypto interface (740) providing functionality for using the generated keys in encryption and decryption of data blocks and also generating cryptographically secure random numbers. An SKG unit supports the access interface and the SKG interface.

More over the invention relates to a method of synchronising a communication session for encrypted transmission or authentication using an arrangement, comprising the steps of: a first main step of initiation from the first unit, a second main step of verification by the second node, a third main step of verification by the first node, and a fourth main step of completing the synchronization in the second unit.

The first main step further comprises: defining a first key generator identity (SID), by first unit, generating by the first unit a first signature, transmitting by the first unit the key generator identity and the first signature to the second unit.

Preferably, the key generator identity is saved in a unit registry or a local database.

The second main step further comprises: receiving the key generator Identity and first signature by the second unit, finding a key generator by the second unit initialized with the first key generator id, verifying the first signature, and if verification falls, aborting the synchronization and returning to its initial state, if a successful verification synchronizing the key generator of the second unit, generating a first signature by the second unit and transmitting It together with a second key generator identifier to the first unit.

In above step, all known modules and units are investigated by the second unit until a matching key generator identity is found and a function for finding identity in a SKG manager interface is called and a result is cached and used as a reference to all further calls during the session.

The method further comprises searches for local units for a key generator coupled with a specified remote identity.

The third main step further comprises: a. receiving by the first unit the SID and the second signature generated in unit, b. verifying and synchronizing by the first unit its key generator if the verification is successful, c. generating a next session key by the first unit, d. generating a second signature by the first unit, and e. transmitting the result to the second unit.

In step e, the first unit starts using the session key and sends encrypted data.

The fourth main step further comprises: receiving by the second unit the second signature, verifying the second signature, getting a next key from the key generator and using it as the session key, and using the session key for encryption.

The invention also relates to a method for synchronization of a communication session for encrypted transmission or authentication between at least two units via an insecure communication channel, comprising the steps of: In an Initiation procedure, obtaining a common original value to be used in the respective units; a handshake procedure whereby a synchronization is obtained by successively communicated signatures between the communicating units, generating a key on the basis of the original value (seed), the present key and the session counting value in each unit, independently of other units; and increase the session counter by a number, and using the thus generated keys in a subsequent encrypted transmission or authentication operation. According to this embodiment, the original value is saved in a dynamic and exchangeable fashion at least in one of the units, and preferably in all units. The counting value is generated in a counter in each unit, the synchronisation of the counting values involving synchronisation of the counters. Following the initial synchronisation of the counters, the units execute supplementary synchronisation steps only when needed.

The invention also relates to a computer program for synchronization of a communication session for encrypted transmission or authentication between at least two communicating units, a first unit and a second unit each unit comprising a session counter, via a communication channel, the computer program comprising a set of instructions for a handshake procedure, a set of instruction sets for synchronization of session counters obtained by successively communicated signatures between the communicating units.

Another aspect of the invention relates to a memory for use in system for synchronization of a communication session for encrypted transmission or authentication between at least two communicating units, a first unit and a second unit each unit comprising a session counter, via a communication channel, the memory comprising a data structure for a handshake procedure, a data structure for synchronization of session counters obtained by successively communicated signatures between the communicating units.

The invention further relates to a computer program readable medium having stored therein an Application Program Interface (API) for synchronization of a communication session for encrypted transmission or authentication between at least two communicating units, a first unit and a second unit each unit comprising a session counter, via a communication channel, the computer program readable medium comprising a set of instructions for a handshake procedure, a set of instruction sets for synchronization of session counters obtained by successively communicated signatures between the communicating units.

The invention also relates to a method for a network device to synchronize a communication session for encrypted transmission or authentication with a second device, each comprising a session counter, via a communication channel, the method comprising a handshake procedure for synchronization of session counters obtained by successively communicated signatures between the communicating devices.

### SHORT DESCRIPTION OF THE DRAWINGS

In the following, the invention will be described with reference to a number of exemplary embodiments illustrated in the drawings, in which:

FIG. 1 is a diagram illustrating synchronization between two nodes In a communication network implementing the present invention,

FIG. 2 is a schematic illustration of the message transmission between the nodes of FIG. 1,

FIG. 3 shows synchronization steps in nodes A and B of FIG. 1,

FIG. 4 illustrates a block diagram of a smartcard, employing the teachings of the invention,

FIG. 5 illustrates another communications network implementing the present invention,

FIG. 6 is a hierarchy block diagram of a managing system according to the invention,

FIG. 7 illustrates block diagram of an interface unit implementing the invention,

FIG. 8 shows synchronization steps in nodes A and B of FIG. 1 in relation to a managing system, and

FIG. 9 illustrates a system for secure encrypted transmission/authentication between two units according to one embodiment of the invention.

### DETAILED DESCRIPTION OF THE PREFERRED EMBODIMENTS

Traditionally, it is normal to use some kind of clock to synchronise two independent nodes knowing that the clock must always be in synch. To get around the inconveniences with problems like this the invention provides a “handshake” method. Each start up of a new communication session implies a handshake process according to the invention to verify that the communicating party is the one it is supposed to be (correct signature) and that the same key is created on each side. If all parameters are correct a new key for use is created otherwise the communication is not executed.

According to the invention, the keys are algorithmically generated with the help of a widely accepted and tested secure HASH algorithms, such as SHA-1, FIPS 180-1, to ensure the highest security in the system.

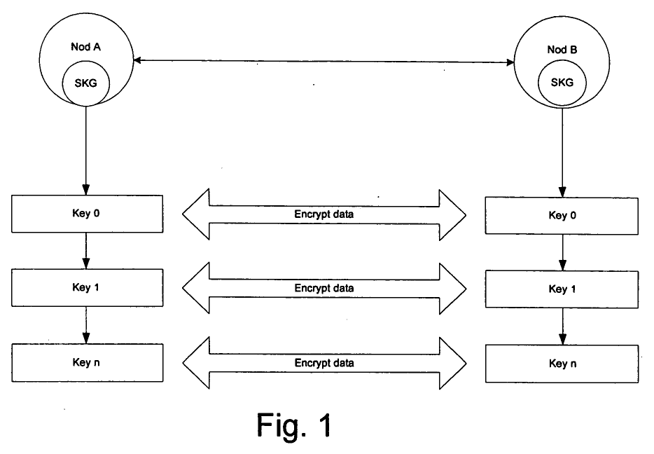

FIG. 1 illustrates a key transaction flow between two nodes A and B. The nodes generate keys 0-n, wherein n is an integer, and transmit data encrypted with the generated keys. When a communication session is to begin, one must be certain that the key generators on both sides are synchronized, i.e. they will generate the same key.

Any kind of encryption method can be used since SKG is only a key generator and key handler. The key is called upon via a command, here called Get Key, e.g. to an API.

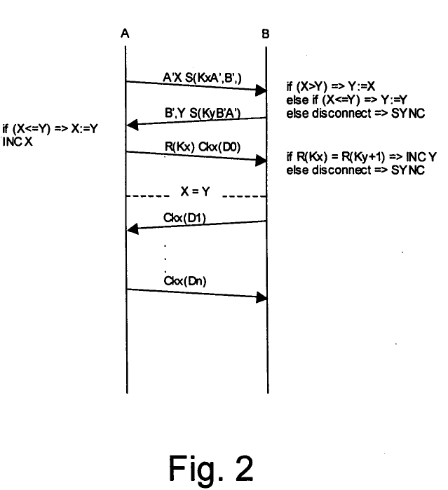

FIG. 2 shows how the synchronization is performed when, for example node A initiates the communication. The SKG has to be initiated with a common key (seed) for the synchronization according to the present invention. This seed (KO) is only used in the beginning and can be replaced at any time but cannot be accessed by an outsider, e.g. through hardware access limits.

The synchronization according to the present invention is a method using signatures to guarantee synchronization of the session counters X and Y. A′ and B′ are the SID (unique ID) for each side. The functions S(KAB) and R(K) are signature generator functions described below.

The objective of the synchronization process is to guarantee that a key is never reused by agreeing over which side, A or B, has the key with the highest index and using this key as a base for calculating the next session key. In FIG. 2:
A generates a message [A′XS(KxA′B′)] consisting of A's identity “A′” concatenated with A's key index “X” concatenated with a hash-value “S”. The S-value is calculated by hashing the key “Kx” with index X concatenated with A's identity “A′” and B's identity “B′”. The message is transmitted to B.

B receives the message and compares its key index Y with the received X. If X is greater than Y, B knows that it needs to generate keys up to index X to be in sync. If X is less than or equal to Y, B knows that A must generate keys up to index Y. The S-value can be calculated by B and compared to the transmitted S-value. If the S-values are equal, then B can trust the claim that A's current key index is X, since only A and B can generate the right S-value for a certain key. If not, the synchronization process is aborted and B reverts to its original first key Ky.
B now generates keys up to Index X if X was greater than Y, thereby establishing that Y is greater or equal to X. The message [B′YS(KyB′A′)] consisting of B's Identity “B′” concatenated with B's key index “Y” concatenated with a hash-value “S” is created. The S-value Is calculated by hashing the key “Ky” with Index Y concatenated with B's identity “B′” and A's identity “A′”. This message is then transmitted back to A.
A receives the message and compares its key index X with the received Y. If A's key index X is less than Y, then A must generate keys up to index Y, establishing a key index where X equals Y. This is only performed if the received S-value compares to the generated S-value, thereby certifying that B's claim of being at key index Y is correct.
At this point, A and B are at the same key index. A can generate the next key (Kx where the index X is incremented by 1), which is going to be used as the session key. An R-value is calculated by hashing the newly generated key and transmitted to B (optionally along with the first payload, D0, encrypted with the new key using the function Ckx(D0)). The message [R(Kx)Ckx(D0)] is transmitted to B.
B receives the R-value, generates the next key and calculates its R-value. The R-values are compared and if equal, B keeps this state (key index) in its key generator and can now decrypt the first payload. If the R-values differ, there is an error and the entire process is aborted and B reverts to its original first key Ky.

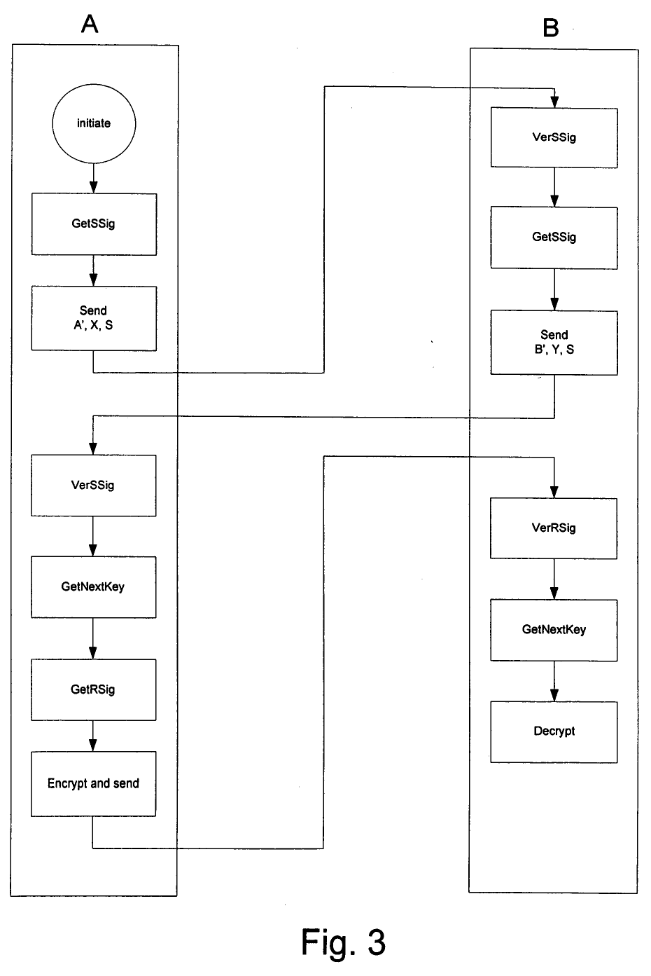

Following Is an example, illustrated in conjunction with FIG. 3 disclosing the synchronization method of the invention:
Side A initialize the communication by sending its Identity A′ (SID), current session counter X and the S signature to B. The S signature is calculated by calling GetSSig( ) in the API.
Side B receives the data and calls VerSSig( ) to perform the synchronization described in the FIG. 2.
Side B also calls GetSSig( ) and sends its identity B′, session counter Y and S signature.
Side A verifies the S signature from B. A call VerSSig( ) to perform the synchronization.
A knows that A and B are synchronized and calls GetNextKey( ) to get the next key for encryption.
Side A calls GetRSig( ) (after the call to get next key) and sends this signature to B. A can now encrypted the data and transmit it.
B checks this signature with its K_{y+1} by calling VerRSig( ) and if they match B calls GetNextKey( ).
B now knows that A and B are synchronized and can decrypt the data.

The above-mentioned functions can, preferably but not exclusively, be defined in an API key-generator, and have following functionality:

GetSSig( ): fetches S signature

Takes as parameter the SID identifying the key generator and a pointer to a buffer containing X II S(K_{X}AB).

VerSSig( ): Verifies the S signature.

Takes the SID connected to a key generator and a pointer to a buffer containing Y II S(K_{Y}BA).

GetRSig( ): Fetches the R signature.

Takes the SID identifying the key generator and a pointer to a buffer containing R(K_{X}AB).

VerRSig( ): Verifies the R signature.

Takes the SID connected to a key generator and a pointer to a buffer containing R(K_{Y+1}BA).

GetNextKey( ): Fetches the next key from the key generator with obtained SID Takes the SID identifying the key generator and a reference to the next key.

Hashing the signature function parameter creates the signatures. The algorithm SHA-1, for example, is used to hash different in-data and for computing a condensed representation of a message or a data file. Other algorithms can be used for example SHA-256, MD5 and similar.

For the SKG to be Implemented in other existing hardware designs such as Smartcard silicon, some components are needed.

An example of an environment like this Is ATMEL:s AT90SC silicon for Smartcards, in which SKG can be Implemented as an authentication and encryption method, e.g. for secure “chat” purposes.

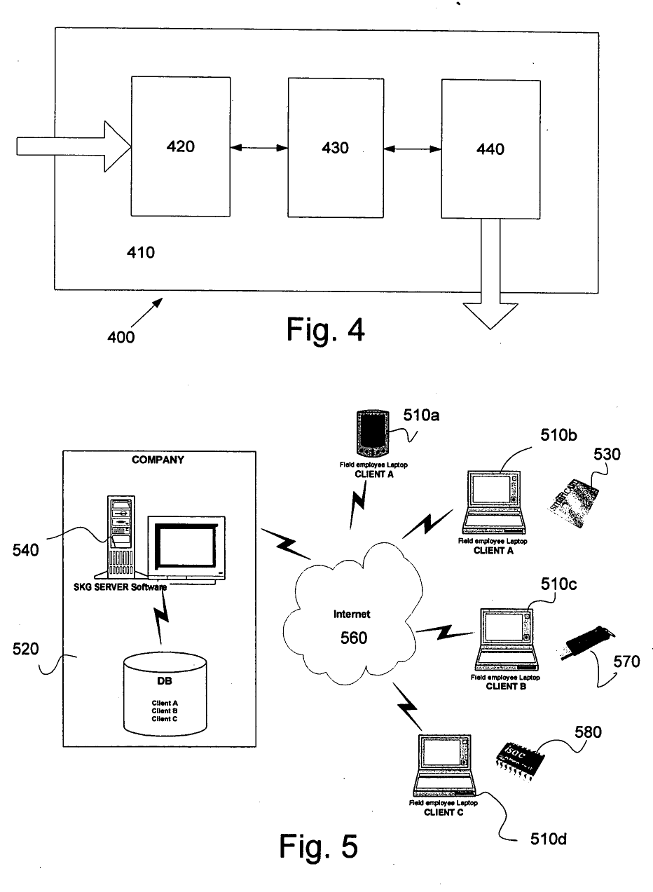

FIG. 4 illustrates an example, such as a smartcard 400 in which the invention is implemented. The smartcard comprises a non-manipulative area 410, an application code memory 420, a processing unit 430 and a memory 440 for session key storage. The processing unit controls the memory units' function and code memory and communication. It should be appreciated that the smartcard and its functional units are given only as an example and other appearances and applications may occur. By using SKG in a Smartcard the ability to integrate in existing environments is facilitated. To implement SKG in a Smartcard environment one needs the development platform for the processor kernel and programming tools for the actual Smartcard. The Smartcard has to have non-volatile memory onboard (E2PROM/Flash). The size of that memory sets the limit of how many keys it can generate. It's desirable to use high security classified Smartcards for best security (EAL 4+).

According to one example, as illustrated in FIG. 5, secure communication can be achieved between field clients 510a-510d and their company 520 by using, e.g. a SKG Smartcard 530 as described earlier, at the client nodes and an SKG application 540 at the company node. The communication is carried out through, e.g. Internet 560 or other communication network. By using the application at the company node it is possible to handle a huge numbers of clients. At the client side, the SKG can also be implemented as:
Software
USB-Dongle (arbitrary USB memory keys) 570
Bluetooth unit 580
RF unit (580)
WLAN units
RFID
Biometric unit (580)

All units can communicate via a module driver to its application. These drivers can be developed specific for the unit. Software-, Smartcard- and USB dongle-units are already on the market.

A strong encrypted file containing the key engine and register can represent the software module. This is most common on the server side and can be used even on the client.

The USB dongle 570 is either a flash memory or a more powerful unit that is very much similar to a Smartcard but with a USB interface. The advantage is that there is no need to use a specific reader for the unit since USB is a common standard in most computers.

The Bluetooth area suffers from adequate security. SKG can easily be adjusted to take care of the key handling to bring Bluetooth to a high-level security information bearer.

WLAN according to 802.11, 802.11b, etc., also suffers from adequate security. SKG can easily be adjusted to take care of the key handling.

RF devices are frequently used in a wide range of areas but mostly as identification tags in passage systems. One problem is that the tag Id is a static key that looks the same every time. By implementing SKG it is possible allow the tag to be a trigger for the SKG that generates a new key every time a person passes the gate.

Biometric units are very suitable on identifying the user and as such it can add value to the SKG technique. But as stand-alone, it suffers from the same problems that RF has, namely the same identity every time (one fingerprint). By letting the fingerprint trig the SKG to generate a new key every time a person identify himself, the highest level of security is reached.

By configuring SKG to handle more than one key generator, each such a generator will act as a separate communication channel. Thus, It is possible to use one single SKG device for several communication purposes/applications. For instance, one Smartcard can be used for passage systems, computer logon, bank transfers etc. where each application uses its own SKG channel. By using only one SKG device, such as a Smartcard, the users only have to identify themselves against one device, using only one identification, such as a PIN code.

Moreover, an SKG able device can have several usability layers, e.g. one user level where the user is able to change PIN code and one administrative level where the setup of multi channels etc. is managed. Each layer can be protected by an encrypted login routine.

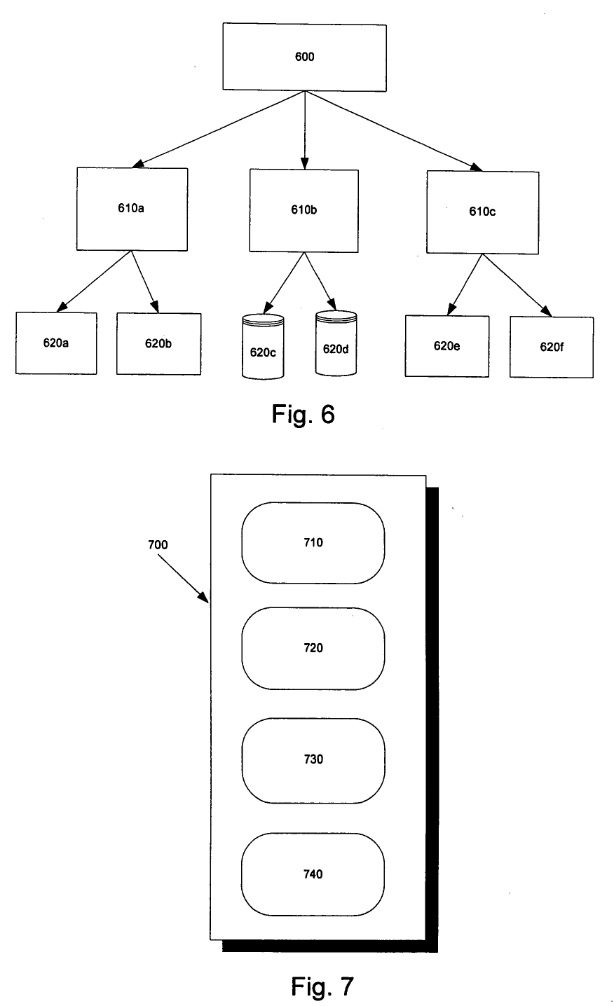

FIG. 6 illustrates an SKG Manager (SKGM) 600, which can be used as the common access point to all SKG engines installed In a system. Its module 610a-610c, and a sub object of the SKGM define an SKG engine. The module implements a communication interface with a certain type of SKG unit 620a-620f. All applications wanting to access these engines can use the SKG manager, which then manages the resources.

In most preferred embodiment, an application can use the SKGM, e.g. by loading a Dynamic Link Library (DLL) or a device driver either implicit or explicit. The accompanying header files contain the definitions and declarations necessary to use the DLL.

The SKGM is an implementation of system SKG on a computer unit. The manager manages a number of modules, which represent different types of units. In SKG unit the key generators reside. A unit can be of different nature, a smartcard, an USB-dongle, a file on disk, a database table etc. The unit 700, as illustrated in FIG. 7, has four different interfaces (grouping of functionality):
The Access interface 710 includes functions for formatting, logging in/out, locking the unit etc.
The SKG interface 720 contains all functions that handle the key generators such as allocating, initializing, generating and synchronizing.
The Registry interface 730 implements a small registry used for applications to securely store and retrieve configuration and other types of persistent data in the SKG unit.
The Crypto interface 740 provides the functionality for using the generated keys in encryption and decryption of data blocks and also generating cryptographically secure random numbers.

An SKG unit does not need to support all of the four interfaces and there is a way of querying it for the supported Interfaces. However, the Access interface and the SKG interface must always be present.

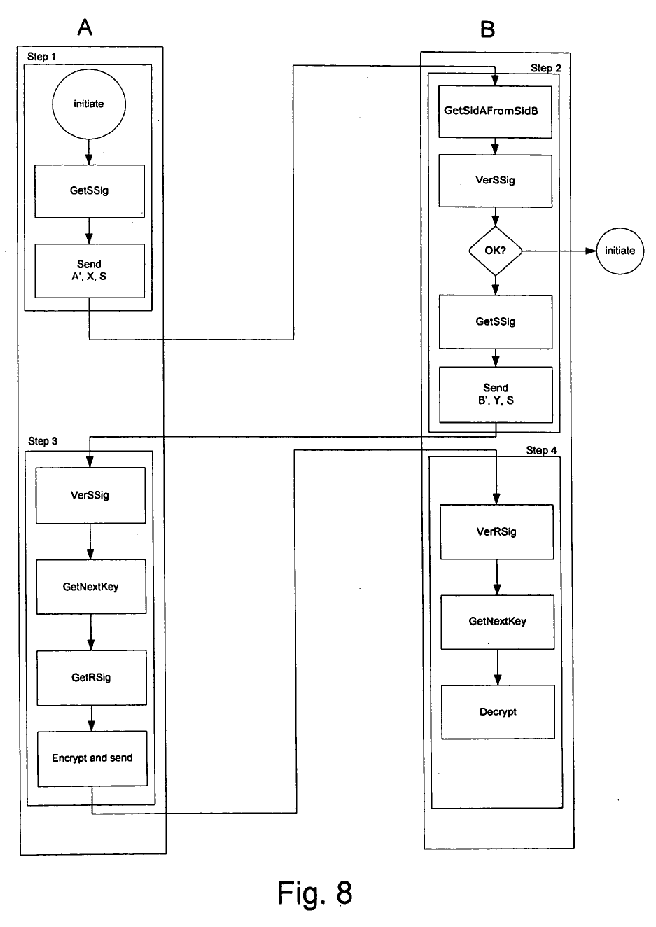

In the following references are made to FIGS. 1 and 8.

When a communication session is to begin, the key generators on both sides must be synchronized, i.e. they will generate the same keys.

To accomplish this, the SKG interface of the SKG Manager exposes some useful API calls. In order to make a secure synchronization of the two key generators the synchronization method according to the Invention is performed.

Each node A and B (FIG. 1) has a key generator identifier (SID) specially dedicated for communication with the other node.

Assume that node A decides to initiate the synchronization.

Step 1: Initiation from Node A (FIG. 8)

The application at node A must know the identity of the key generator (SID), which it uses for communication with node B. This could be saved in the unit registry or in some other local database. When node A knows which key generator identifier (SID) to use, it generates a unique signature (S-signature) by calling the function GetSSig( ). Data is now ready to be transferred over the application protocol in use. Node A transmits the SID and the S-signature (which includes the bump count) to node B.

Step 2: Verification in Node B

The application at node B receives the SID and the S-signature generated in node A. From node Bs perspective, the key generator identifier (SID) from node A is SID-B. Node B needs to find Its own key generator (SID-A) initialized with the SID-B and calls the (API) function GetSidAFromSidB( ). All known modules and units must be investigated until a matching SIDA Is found. An alternative method Is to call a function FindRemoteSid in the SKGM interface. A good design role is to cache the result from this operation since the returned Sid-A will be used as a reference to all further API calls during the session. Node B now calls the function VerSSig( ) with the S-signature received from node A. If GetSidAFromSidB( ) or VerSSig( ) fails, the synchronization should be aborted and node B returns to its initial state. It is up to the application to decide if node Alfa should be notified that synchronization is not possible. After a successful call to VerSSig( ) node B knows the correct bump count value and its key generator is synchronized. However, node A does not know which key to use for this session and node B does not know if A is synchronized. Node B calls GetSSig( ) and sends its own key generator identifier (SID) together with the result to node A.

FindRemoteSid searches the local units for a key generator coupled with a specified remote SID, also called SidB in some functions. The local SID of the key generator and the unit on which it resides is returned if found.

Step 3: Verification in Node A

The application at node A receives the SID and the S-signature generated in node B. By calling the function VerSSig( ), node A synchronizes its key generator if the verification was OK. Node A now knows that both A and B are synchronized. It is safe to generate the next session key by calling the function GetNextKey( ). Node A must now prove to node B that node A is synchronized. Node A calls the function GetRSig( )and sends the result to node B. It is also possible for the application at node A to start using the session key and send encrypted data.

Step 4: Complete the Synchronization in Node B

The application at node B receives the R-signature and passes it to the function VerRSig( ). This function verifies for node B that node A is synchronized and that node A has made a correct next key. Node B knows that it should get the next key from the key generator and use it as the session key. Node B calls the function GetNextKey( ) and starts to use the session key for encryption.

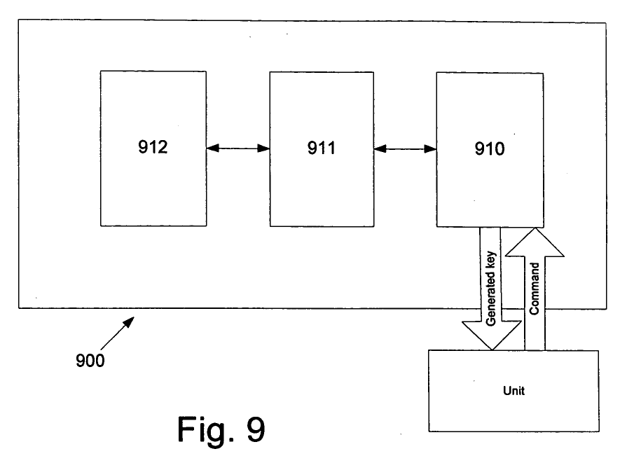

FIG. 9 illustrates a preferred embodiment using the invention, which relates to a system for secure encrypted transmission/authentication between two units via an insecure communication channel. The communication channel could be any channel via which data may be transmitted, and more specifically, the channel could be stationary as well as wireless. Each such unit comprises a key-generating unit 900. The key-generating units comprise a memory 910, wherein identical original values SID, so called seeds, have been stored, preferably in a dynamic/fixed and inter/exchangeable manner. The storage of original values preferably is effected in connection with the Introductory Initiation of the units, and advantageously it could be effected via a secure channel. Possibly, the original values need not, however, be transmitted physically but Instead the users of the units concerned may themselves input an pre-agreed value. In addition, the original values may be exchanged, when needed, but alternatively the same original values are used for the duration of the entire life of the key-generating unit. In this case the original values need not be stored in dynamic memories, but instead permanent memories may be used.

In addition, the key-generating units comprise a counter X that represents number of keys generated.

Provided that the same original values are stored in the memory 910 and that the counters are synchronised to deliver the same counting value, identical keys may be generated in several key-generating units, independently of one other.

These keys may then be used for encrypting or authenticating purposes between the units.

Furthermore, the key-generating units preferably are adapted to sense whether they are synchronised or not, and in case they are not, to implement this synchronisation. Sensing may be performed by means of a particular synchronising test that is performed prior to the generation of keys.

Alternatively, a need for synchronisation may, however, be identified when different keys are used, and only thereafter may synchronisation resetting be effected. Synchronisation may be effected for example by exchange of counting values between the units.

The calculating unit comprises a calculating algorithm F, which hashes the original value (seed), present key and the counting value as input parameters. Thereafter the count value increases by a number i.e. count=count+1. This calculating algorithm preferably is implemented In hardware in the calculating unit, or alternatively it Is stored in a non-dynamic and unchangeable memory. The calculating algorithm preferably generates a 160-bit key, but keys of other lengths are of course also conceivable. Every time an order is given to the key generator to produce a new key therefore a new pseudorandom 160-bit word is generated, which is calculated on the basis of the “seed” and the counting value.

The key-generating unit 900 further comprises an Interface part 912 serving to enable communication between the communicating unit and the key-generating unit. Preferably, this communication comprises emission of instructions to the key-generating unit to generate a key and the emission of a thus generated key back to the communicating unit.

Advantageously the key-generating unit is implemented in hardware and executed in the form of an integrated circuit, thereby making it more difficult to tamper with. This circuit may then be added to and used together with essentially any type of communicative unit. For example, it is possible to use the key-generating unit in accordance with the invention together with rechargeable cards, so called smart cards, in portable or stationary computers, in mobile telephones, electronic calendars and similar electronic equipment that is communicative.

However, it is likewise possible to implement the key-generating unit in software for example in a conventional computer, and to use existing memories and the like. This alternative is particularly advantageous for implementation in stationary units, and in particular units that are used as central units.

The key-generating units in accordance with the invention may be used either for point-to-point communication or authentication, i.e. between two units, or between a central unit, a server, or several users, clients. Such a central unit preferably comprises a plurality of different key-generating units, one for each client in communication with the central unit. Alternatively, a key unit could comprise several different original values, in which case the command to the key-generating unit to generate a key also comprises information regarding which original value should be used. It is likewise possible for several units that communicate with the central unit to have identical key generating units, enabling them to communicate with the same key-generating unit in the central unit.

In the case of a central unit, adapted to communicate with several other units, the central unit preferably comprises a means for software implementation of the key generation unit whereas the clients have hardware implemented means. For example, the clients could be smart cards or mobile telephones, computers and the like. Thus, the system in accordance with the invention may be used between a bank and its clients, between enterprises and their employees, between a company and its subsidiaries, and so on. In addition, the system may be used to control access to home pages via Internet or the like, for example by connecting its smart card to a reader provided for that purpose, and in this manner it becomes possible also to control the access to electronic equipment that communicates wireless for example via Blue-tooth or WLAN.

Also units that are not central units may comprise several original values, in the same key-generating device or in separate units, in order to communicate via several separate channels. In this manner the unit may be used for communication with several different central units. For example, a smart card may be used for communication with several different banks or other establishments.

In the following an encrypted transmission or authentication with the aid of the system of FIG. 9 will be described. In a first step, the units intended for future intercommunication are initiated, in which process they are provided with identical original values and preferably are also synchronised. The system is now ready for use, and at a later time, which may occur after the lapse of an arbitrary period of time after the initiation, the units are interconnected via an insecure communication channel, and at least one of the units identifies itself to the other. In the next step, the other unit determines whether the identity given is known and whether it has a corresponding key-generating circuit, i.e. a key-generating circuit as defined above and with a corresponding original value. If this is the case, the process proceeds to next step, otherwise the process is interrupted.

The units then agree to execute encrypted transmission or authentication, whereby each one separately calculates keys in the respective key-generating unit. Before this happens, a synchronisation test might have been made to investigate whether the counters in the respective key-generating units are synchronised. If this is the case, the process continues directly to next step, otherwise a synchronisation step as described in conjunction with the earlier embodiments (FIGS. 3 and 8) is first executed to reset the inter-unit synchronisation.

The calculated keys are then used to execute encrypted transmission or authentication. It should be understood, however, that encrypted transmission and authentication of course may be effected simultaneously and in the same process. Encrypting and authentication may be effected with the aid of essentially any encrypting algorithm that uses keys, as the known DES and RC6 etc.

The invention may be used for authentication, i.e. verification that the unit with which one communicates is the one it claims to be, as well as for key-generation for encrypted transmission purposes. The units that are used in connection with the present invention, such as smart cards, telephones and the like, could however advantageously be equipped with means arranged to ensure that the unit user is the correct one, i.e. authentication between users and the communicating unit. Such authentication may be effected with the aid of input of a code, identification of fingerprints and the like.

Several varieties of the system and the method described above are possible. For example, the method and the system do not depend on the encrypting or authentication method used but may be used in a simple and secure manner to generate keys, and consequently it may be used together with most known methods of this kind. In addition, the key-generating unit preferably is implemented in hardware, which makes the key-generating process completely hidden to the user. It is, however, also possible to implement the key-generating unit in software in an ordinary computer or processing unit. In addition, the units in the system may be essentially any communicative electronic units. The counters used to generate the counting values for the key-generating units could also be of any type, provided that they generate counting values that vary with time. It is likewise possible to omit counters in one or several units, and in this case the step of synchronising the counters is replaced by a step involving exchange of counting values between the units, i.e. to synchronise the counting values, before each key-generating operation. Such and other obvious varieties must be regarded to be within the scope of protection of the invention as the latter is defined in the appended claims.

The invention is not limited to the illustrated and described embodiments. Variations and alternative embodiment within the scope of the attached claims may occur depending on the needs, demands and functionality requirements.

1. A method for synchronization of a communication session for encrypted transmission or authentication between at least two communicating units, a first unit and a second unit each unit comprising a session counter, via a communication channel, wherein the method comprises a handshake procedure whereby the synchronization of session counters is obtained by successively communicated signatures between said communicating units.

2. The method of claim 1, wherein keys are generated identically and synchronously in physically separated locations without providing information about a key, online or offline.

3. The method of claim 1, wherein each unit is initiated with a common “seed”, a key for the synchronization.

4. The method of claim 3, wherein said common key is only used in an initial step and can be replaced at any time.

5. The method of claim 1, comprising the steps of:
a. first unit initializing the communication by sending a data set comprising said first unit's identity, a current session counter and a first signature to said second unit,
b. receiving by said second unit said data,
c. verifying said signature to perform the synchronization,
d. said second unit fetches said first signature and sends its identity, a second session counter and said first signature,
e. verifying by said first unit said first signature from said second unit,
f. performing a synchronization by said first unit,
g. obtaining a new key for encryption by said first unit, if both units are synchronised,
h. generating a new signature by said first unit and providing it to said second unit,
i. verifying by said second unit said second signature, and
j. generating a new key by said second unit upon positive verification of said second signature.

6. The method of claim 5, wherein said first unit encrypts data and transmits data after step h.

7. The method of claim 5, wherein said second unit decrypts data received from said first unit after step j.

8. The method of claim 1, wherein the signatures are generated as a HASH value of any size.

9. The method according to claims 8, wherein said signatures are generated using one or several of algorithms SHA-1, SHA-256 MD5 etc.

10. The method of claim 1, wherein a key is never reused by agreeing over which unit, has the key with a highest index and using this key as a base for calculating a next session key.

11. A communication network comprising at least two communicating units, communicating via a communication channel, each unit comprising means for synchronization of a communication session for encrypted transmission or authentication between said at least two communicating units, a first unit and a second unit, characterised in that each unit comprises means for a handshake procedure where a signature and synchronization procedure takes place by successively communicated signatures between said communicating units.

12. The network of claim 11, wherein said means comprises a non-manipulative area, an application code memory, a processing unit and a memory for session key storage.

13. The network of claim 12, wherein said means consists of a smartcard, software application, a USB-Dongle, Bluetooth unit, RF unit, WLAN or a biometric unit.

14. The network of claim 13, wherein said software application comprises an encrypted data set containing a key engine and register.

15. The network of claim 11, wherein said means handles more than one key generator, each such a generator acting as a separate communication channel.

16. A synchronous key generator (SKG) management arrangement, which can be used as a common access point to several synchronous key generator engines installed in a system for synchronization of a communication session for encrypted transmission or authentication between at least two communicating units, a first unit and a second unit, each unit comprising a session counter, said arrangement comprising at least one communication interface with a certain type of SKG unit, wherein each unit comprises means to initiate a handshake procedure whereby the synchronization of session counters is obtained by successively communicated signatures between said communicating units.

17. The arrangement of claim 16, wherein an application uses said arrangement by loading a device driver.

18. The arrangement of claim 16, wherein manager arrangement manages a number of modules, which represent different types of units.

19. The arrangement of claim 16, wherein each SKG unit includes a key generator.

20. The arrangement of claim 16, wherein a unit is one of a smartcard, an USB-dongle, a file on disk or a database table or other memory based devices.

21. The arrangement of claim 20, wherein a unit comprises different interfaces:
an access interface, including functions for formatting, logging in/out, locking the unit,
an SKG interface contains functions that handle the key generators such as allocating, initializing, generating and synchronizing,
a registry Interface Implementing a registry used for applications to securely store and retrieve configuration and other types of persistent data in the SKG unit, and
a crypto interface providing functionality for using the generated keys in encryption and decryption of data blocks and also generating cryptographically secure random numbers.

22. The arrangement of claim 20, wherein an SKG unit supports the access interface and the SKG interface.

23. A method of synchronising a communication session for encrypted transmission or authentication using an arrangement, which can be used as a common access point to several synchronous key generator engines installed in a system for synchronization of a communication session for encrypted transmission or authentication between at least two communicating units, a first unit and a second unit, each unit comprising a session counter, said arrangement comprising at least one communication interface with a certain type of SKG unit, wherein each unit comprises means to initiate a handshake procedure whereby the synchronization of session counters is obtained by successively communicated signatures between said communicating units, the method comprising:
a first main step of initiation from said first unit,
a second main step of verification by said second node,
a third main step of verification by said first node, and
a fourth main step of completing the synchronization in said second unit.

24. The method of claim 23, wherein said first main step further comprises:
a. defining a first key generator identity, by first unit,
b. generating by said first unit a first signature,
c. transmitting by said first unit said key generator identity and said first signature to said second unit.

25. The method of claim 23, wherein said key generator identity is saved in a unit registry or a local database.

26. The method of claim 24, wherein said second main step further comprises:
receiving said key generator identity and first signature by said second unit,
finding a key generator by said second unit initialized with said first key generator id,
verifying said first signature,
if verification fails, aborting the synchronization and returning to its initial state,
if a successful verification synchronizing the key generator of said second unit, and
generating a first signature by said second unit and transmitting it together with a second key generator identifier to said first unit.

27. The method of claim 26, wherein in step b, all known modules and units are investigated by said second unit until a matching key generator identity (SIDA) is found.

28. The method of claim 26, wherein in step b, a function for finding identity in a SKG manager interface is called and a result is cached and used as a reference to all further calls during the session.

29. The method of claim 28, further comprising searches for local units for a key generator coupled with a specified remote identity (SID-B).

30. The method of claim 23, wherein said third main step further comprises:
a. receiving by said first unit the SID and the second signature generated in a second unit,
b. verifying and synchronizing by said first unit its key generator if the verification is successful,
c. generating a next session key by said first unit,
d. generating a second signature by said first unit, and
e. transmitting the result to said second unit.

31. The method of claim 30, wherein in step e, said first unit starts using the session key and sends encrypted data.

32. The method of claim 23, wherein said fourth main step further comprises:
receiving by said second unit said second signature,
verifying said second signature,
getting a next key from the key generator and using it as the session key, and
using the session key for encryption.

33. A method for synchronization of a communication session for encrypted transmission or authentication between at least two units via an insecure communication channel, comprising the steps of:
in an initiation procedure, obtaining a common original value to be used in the respective units;
a handshake procedure whereby a synchronization is obtained by successively communicated signatures between said communicating units,
generating a key on the basis of the original value (seed), the present key and the session counting value in each unit, independently of other units;
increase the session counter by a number using the thus generated keys in a subsequent encrypted transmission or authentication operation

34. The method as claimed in claim 32, wherein the original value is saved in a dynamic and exchangeable fashion at least in one of the units, and preferably in all units.

35. The method as claimed in claim 32, wherein the counting value is generated in a counter in each unit, the synchronisation of the counting values involving synchronisation of the counters.

36. The method as claimed in claim 34, wherein following the initial synchronisation of the counters, the units execute supplementary synchronisation steps only when needed.

37. A computer program for synchronization of a communication session for encrypted transmission or authentication between at least two communicating units, a first unit and a second unit each unit comprising a session counter, via a communication channel, the computer program comprising a set of instructions for a handshake procedure, a set of instruction sets for synchronization of session counters obtained by successively communicated signatures between said communicating units.

38. A memory for use in system for synchronization of a communication session for encrypted transmission or authentication between at least two communicating units, a first unit and a second unit each unit comprising a session counter, via a communication channel, the memory comprising a data structure for a handshake procedure, a data structure for synchronization of session counters obtained by successively communicated signatures between said communicating units.

39. A computer program readable medium having stored therein an Application Program Interface (API) for synchronization of a communication session for encrypted transmission or authentication between at least two communicating units, a first unit and a second unit each unit comprising a session counter, via a communication channel, the computer program readable medium comprising a set of instructions for a handshake procedure, a set of instruction sets for synchronization of session counters obtained by successively communicated signatures between said communicating units.

40. A method for a network device to synchronize a communication session for encrypted transmission or authentication with a second device, each comprising a session counter, via a communication channel, the method comprising a handshake procedure for synchronization of session counters obtained by successively communicated signatures between said communicating devices,

41. The method of claim 40, further comprising the steps of
a. first unit initializing the communication by sending a data set comprising said first unit's identity, a current session counter and a first signature to said second unit,
b. receiving by said second unit said data,
c. verifying said signature to perform the synchronization,
d. said second unit fetches said first signature and sends its identity, a second session counter and said first signature,
e. verifying by said first unit said first signature from said second unit,
f. performing a synchronization by said first unit,
g. obtaining a new key for encryption by said first unit, If both units are synchronised,
h. generating a new signature by said first unit and providing it to said second unit.
i. verifying by said second unit said second signature, and
j. generating a new key by said second unit upon positive verification of said second signature.
